(19) United States
(12) Patent Application Publication
(10) Pub. No.: US 2010/0299340 A1
(43) Pub. Date: Nov. 25, 2010

(54) DISTRIBUTED CONTACT INFORMATION DISCOVERY AND SHARING

(75) Inventors: Narayan Krishna Murthy, Redmond, WA (US); Deepak Achuthan Menon, Redmond, WA (US); Kannan Ramasubramanian, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/470,508

(22) Filed: May 22, 2009

(51) Int. Cl. G06F 17/30

(52) U.S. Cl. 707/759; 707/769; 707/783; 707/776; 707/770; 707/803; 707/812; 707/805

(57) ABSTRACT

A contact sharing system is described herein that allows multiple people to share their address books of contact information so that a person can search for contact information among the address books of the person's existing contacts in addition to any publicly available searchable sources of contact information. Because at least one of a person's contacts is likely to have contact information for the person or business that the person is trying to reach, searching the contacts of contacts is more likely to produce relevant search results than searching anonymous or public sources of contact information alone. Thus, the contact sharing system makes it easier for people to find contact information for people and businesses that they are trying to reach.

### BACKGROUND

Contact information includes many types of data associated with a person, such as a telephone number, email address, instant messaging (IM) identifier (ID), and so forth. For each type of data, a person may have multiple data entries of that type, such as a home telephone number, work telephone number, and mobile telephone number. A person may also have email addresses for work, home, and associated with a mobile device (such as for receiving short message service (SMS) messages). A person may store his/her own contact information using a variety of online services and local applications, such as the Microsoft Windows Address Book (WAB), Microsoft Outlook Address Book (OAB), and an online email server, such as Microsoft Windows Live Mail.

Mobile devices, such as cell phones, personal digital assistants (PDAs), and so forth, are becoming central to communicating with other people. Often, a single device allows multiple types of communication, such as by voice, email, IM, or SMS message. Although a person may know many people, the person may not have contact information for those people available on a mobile device. Even when the person does have one type of contact information, the person may not have contact information for each of the types of communication supported by the mobile device.

People are constantly looking for contact information of other people and of local businesses. Typically, most such information resides within a person's social/business network of contacts. However, to get this information, the person often manually contacts these people in person or searches through other sources (e.g., a phone book or online directory), thus making contact information retrieval a cumbersome process. A person often has an interest in allowing other people to discover his/her contact information, while at the same time wanting to maintain privacy with respect to advertisements or unwanted communications. In current systems, the state of contact information for a particular person is either generally known to the public or completely unlisted, so that the only way to find the information is to contact the person directly.

### SUMMARY

A contact sharing system is described herein that allows multiple people to share their address books of contact information so that a person can search for contact information among the address books of the person's existing contacts in addition to any publicly available searchable sources of contact information. Because at least one of a person's contacts is likely to have contact information for the person or business that the person is trying to reach, searching the contacts of contacts is more likely to produce relevant search results than searching anonymous or public sources of contact information alone. In response to a person searching for a name through the contact sharing system, the system searches at two levels—first on the person's own address book, followed by a search on the address books of each of the contacts in the person's mobile phone address book that also use the central service for storing contact information. Thus, the contact sharing system makes it easier for people to find contact information for people and businesses that they are trying to reach.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the contact sharing system, in one embodiment.

FIG. 2 is a block diagram that illustrates the operation of the contact sharing system between four connected users, in one embodiment.

FIG. 3 is a block diagram that illustrates the state of each users address book following the example illustrated with reference to FIG. 2, in one embodiment.

FIG. 4 is a flow diagram that illustrates the processing of the sharing component of the contact sharing system to share contacts of a user, in one embodiment.

FIG. 5 is a flow diagram that illustrates the processing of the search component of the contact sharing system to search for contact information in response to a user request, in one embodiment.

FIG. 6 is a flow diagram that illustrates the processing of the notification component of the contact sharing system, in one embodiment.

FIG. 7 is a flow diagram that illustrates processing of the update component of the contact sharing system to share contact updates, in one embodiment.

### DETAILED DESCRIPTION

A contact sharing system is described herein that allows multiple people to share their address books of contact information so that a person can search for contact information among the address books of the person's existing contacts in addition to any publicly available searchable sources of contact information. Because at least one of a person's contacts is likely to have contact information for the person or business that the person is trying to reach, searching the contacts of contacts is more likely to produce relevant search results than searching anonymous or public sources of contact information alone. The contact sharing system creates an automatic and temporary contact network based on cross-referenced user address books stored on a central service (e.g., Microsoft Windows Live Contacts).

In response to a person searching for a name through the contact sharing system (e.g., on the person's mobile phone), the system searches at two levels—first on the person's own address book, followed by a search (e.g., first degree) on the address books of each of the contacts in the person's mobile phone address book that also use the central service for storing contact information. In some embodiments, users can provide search authorization indicating whether their contacts can be searched, and the system enforces the provided authorization by searching only allowed address books. If the system finds the requested contact, the system may also performs a consent check to determine whether the contact information can be given and, if so, provides the contact information. For example, the system may send a request to the holder of the contact information to ask if the information can be shared with the requesting person. Thus, the contact sharing system makes it easier for people to find contact information for people and businesses that they are trying to reach.

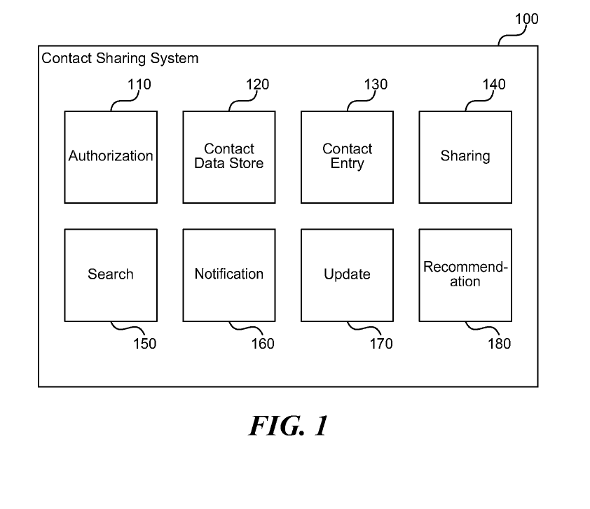

FIG. 1 is a block diagram that illustrates components of the contact sharing system, in one embodiment. The system 100 includes an authorization component 110, a contact data store 120, a contact entry component 130, a sharing component 140, a search component 150, a notification component 160, an update component 170, and a recommendation component 180. Each of these components is described in further detail herein.

The authorization component 110 identifies each user of the system 100. For example, the system may assign each user a username and password so that each user can log into the system, add contact information to the system 100, and search for contact information of other users. The authorization component 110 can use a variety of authorization models well known in the art.

The contact data store 120 stores contact data received from multiple users and provides access to contact data to multiple users. The contact data store 120 may include a database, disk-based storage, Storage Area Network (SAN), cloud-based storage, or any other storage device for persisting data. The contact data store 120 may be accessed by a variety of types of clients (e.g., personal computers, mobile phones, and so forth) over a network (e.g., the Internet, a wireless phone network, and so on). The contact data store 120 is centrally accessible in that multiple clients can access the data store 120 from a variety of locations. However, the contact data store 120 may also operate in a distributed manner, such that multiple peers store contact data and connect to one another dynamically to provide functionality similar to a single central store. Thus, the central nature of the contact data store 120 refers to the wide availability of the data rather than to the selection of any particular storage architecture for its implementation.

The contact entry component 130 provides an interface for receiving contact information manually entered by a user. When contact information is not available through searching, such as when the first user adds a particular person's contact information, the user may manually enter information for the person, such as a phone number, email address, or other contact information. The contact entry component 130 receives manually entered contact information and stores the contact information in the contact data store 120. Once stored in the contact data store 120, the user that stored the contact information can access the contact information, as well as potentially other users that use the contact data store 120, as described further herein.

The sharing component 140 receives sharing access control information from one or more users associated with contact information and stores the access control information in the contact data store 120. For example, a user may specify that some contacts are visible to other users while other contacts are not. The user may also specify levels of access to contact information. For example, the user may allow contacts of the user to view each other's contact information, but not other users of the system 100 that are not related to the user. The sharing component 140 may include a user interface in an application installed on one or more devices associated with the user through which the sharing component 140 receives the access control information.

The search component 150 searches for contact information in response to a user request to find contact information for a particular person. The sharing component 150 may receive information that the user knows about the person, such as a first or last name, and search for information that the user wants to use to contact the person, such as a phone number or email address. The search component 150 searches the contact data store 120 and may include multiple levels of searching including contacts of contacts of the user (1st degree) or deeper levels. The search component 150 may also search broadly across the contact data store 120, such as for users that have voluntarily elected to make their contact information available to other users of the system 100.

The notification component 160 optionally provides a notification either to the user whose contact information the first user requested or to the user through which the system 100 found the contact information. For example, if a user Alpha searches for a user Beta's contact information and the system finds that information in Alpha's contact Gamma's address book, the system may ask either Beta or Gamma for permission to provide the contact information to Alpha. Even though Gamma or Beta may have made this information searchable, the notification component 160 provides an additional level of privacy protection to ensure that users have control over how the system 100 shares their contact information. The notification may be in any of many forms, such as a popup dialog within an application associated with the system 100 running on the user's mobile phone, an SMS message receivable by many types of devices, an email message, and so forth.

The update component 170 optionally provides ongoing updates to contact information shared among multiple users. For example, if a user Alpha discovers Beta's contact information through another user Gamma, and Gamma updates Beta's contact information in Gamma's own address book, the system may also update Alpha's address book with the new information about Beta. Similarly, if Beta updates his own contact information, the system may update the address book of Alpha and/or Gamma with the new information. The update component 170 allows many users to have updated address books without making each user manually update information. The update component 170 also helps users to keep more up to date information about each other for information that may frequently change (e.g., a phone number or postal address).

The recommendation component 180 optionally provides recommendations to a user in response to a search, based on that user's contacts. For example, if the user searches for a dentist, and one or more of the user's contacts have contact information for a dentist stored in their own address books in the contact data store 120, the recommendation component 180 may recommend the dentist of the user's contacts over dentists found in publicly available directories. Users may be more likely to trust businesses with which their friends or other contacts have dealt in the past, thus the recommendation component 180 provides contact information for businesses or people that may be more relevant than publicly available information.

The computing device on which the contact sharing system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

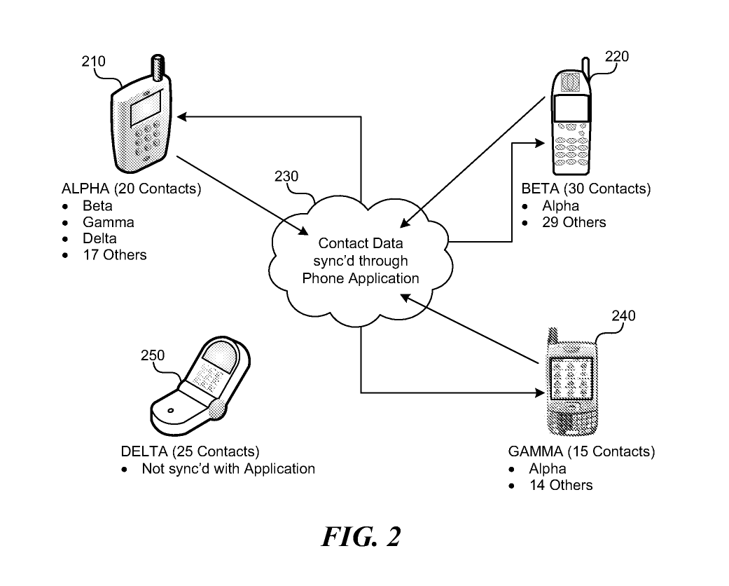

FIG. 2 is a block diagram that illustrates the operation of the contact sharing system between four connected users, in one embodiment. The users Alpha, Beta, Gamma, and Delta each have a mobile phone with an address book. Alpha's mobile phone 210 has 20 contacts stored in the address book, which includes Beta, Gamma, and Delta, while Beta's mobile phone 220 has 30 contacts, which include Alpha. In addition, consider Alpha, Beta, and Gamma have added an application on their phones that enables them to keep their contacts coordinated with a central contact store. They are able to connect to the central contact store 230 from their phones via General Packet Radio Service (GPRS) or other similar data connectivity options. If Beta is looking to add Gamma and Delta to his address book, using the application on his phone 220 Beta searches with Gamma's name first. The contact sharing system performs a first-degree search on all of Beta's contacts and each of their address books stored on the central contact store 230. The system finds Gamma's contact details in Alpha's address book and sends a request to the application on Gamma's phone 240 to get Gamma's permission to contact him. If Gamma accepts the request, the system updates Beta's address book with Gamma's contact information. If Beta wants to add Delta in a similar manner, Delta's contact information would also be found in the same way as before. However, if Delta has not installed the application on his phone 250, the system may send an SMS message to Delta describing Beta's relationship to Alpha and interest in contacting Delta. Delta can then choose to accept or reject the request by replying to the SMS message.

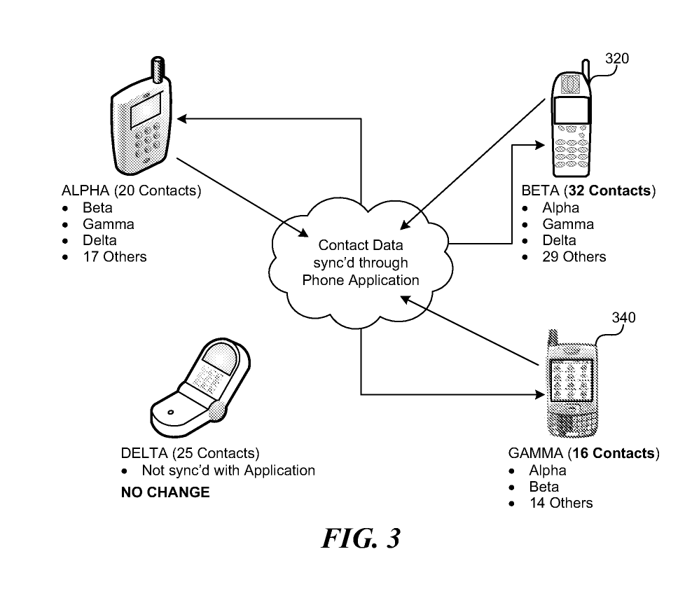

FIG. 3 is a block diagram that illustrates the state of each users address book following the example illustrated with reference to FIG. 2, in one embodiment. Beta's phone 320 now contains two additional contacts, those of Delta and Gamma, the two users Beta was searching for. Gamma's phone 340 now contains contact information from Beta. For example, Gamma may have selected an option to add Beta provided by the system when Gamma received the request to share contact information related to Beta's request.

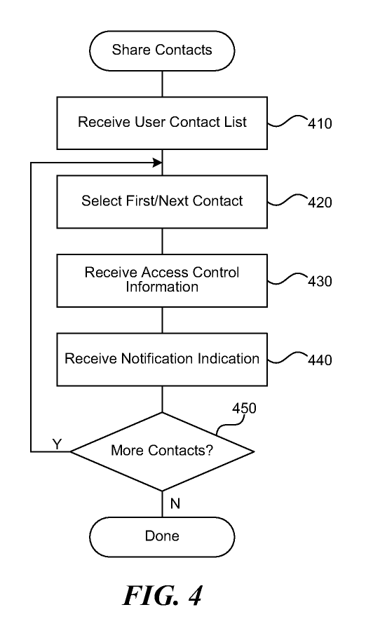

FIG. 4 is a flow diagram that illustrates the processing of the sharing component of the contact sharing system to share contacts of a user, in one embodiment. These steps may be performed in response to the user accessing a sharing user interface of a contact management application on the user's mobile phone or other device. Beginning in block 410, the component receives a list of the user's contacts. For example, the component may download the list of user contacts from a central contact data store that stores relationships between users, such as a contact relationship. The list may include contact information for each contact, such as a first and last name, phone number, or other information that the component can display to the user to identify the contact.

Continuing in block 420, the component selects the first contact in the received list. As illustrated, the user loops through each of the user's contacts to specify access control information. However, the component may also present the list to the user and allow the user to select one or more contacts for which to specify or update access control information. The user may select the contacts by clicking on the list or selecting one or more contacts with a cursor controlled by an input device. Continuing in block 430, the component receives access control information from the user for the selected contact, wherein the access control information indicates whether other users can search the user's contacts to identify contact information for the selected contact. The access control information may indicate categories of users that can access the contact information, such as friends, friends of friends, users that already have some information for the contact (e.g., an office phone number when searching for a home phone number), and so forth.

Continuing in block 440, the component receives a notification indication that specifies whether the user wants to be notified when another user requests information from the user for the selected contact. For example, even though the user indicates that a particular contact can be provided in search results, the user may nevertheless want to explicitly provide authorization at the time of the search. Thus, a searching user may receive results that indicate that the system identified potentially matching contact information but that further authorization is required by sending the holder of the contact information a notification and permission request. Like the access control information, the user may specify that notifications not be sent for certain categories of users. For example, the user may specify that first-degree contacts of the user can find contact information for other contacts of the user without a notification, but that deeper levels of contacts request explicit permission through a notification.

Continuing in decision block 450, if the user has more contacts for which the user wants to specify access control information, then the components loops to block 420 to select the next contact, else the component completes. The system stores (not shown) the access control information and notification indication in the contact data store, so that it is accessible during searches. After block 450, these steps conclude.

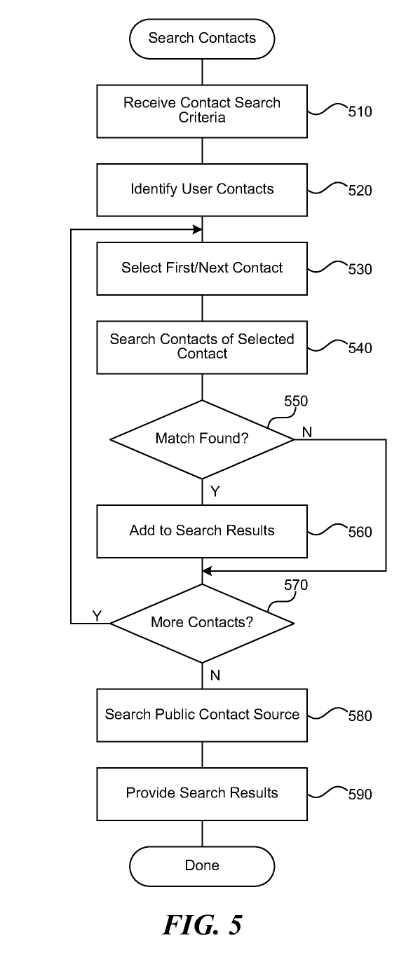

FIG. 5 is a flow diagram that illustrates the processing of the search component of the contact sharing system to search for contact information in response to a user request, in one embodiment. These steps may be performed in response to the user accessing a search user interface of a contact management application on the user's mobile phone or other device. Beginning in block 510, the component receives one or more contact search criteria for finding contact information. For example, the search criteria may include a first and/or last name, business name, address, business category (e.g., restaurant), or other information based on which the user wants to find additional contact information, such as a phone number or email address.

Continuing in block 520, the component identifies contacts of the user that initiated the search. For example, the system may download a list of contacts from a central contact data store that the user is authorized to access. Alternatively or additionally, a device associated with the user may include a cached copy of the contact list. The contact list may include information about each contact, such as a location where each contact's address book can be found. Continuing in block 530, the component selects the first contact of the identified contacts. Continuing in block 540, the component searches the contacts of the selected contact to determine whether a contact matches the received search criteria. For example, an application on the user's mobile phone may send a request to the central contact store to search one or more database tables or other data structures for contacts that match the received search criteria. The search may span more than the user's own contacts to include contacts of the user's contacts recursively at multiple levels of depth to identify potential matches of the search criteria.

Continuing in decision block 550, if the component identifies a matching contact, then the component continues at block 560, else the component continues at block 570. Continuing in block 560, the component adds the matching contact to search results. For example, the component may store a list of identified search results to display to the user as the query progresses. Continuing in decision block 570, if the user has more contacts, then the component loops to block 530 to select the next contact, else the component continues at block 580.

Continuing in block 580, the component optionally searches one or more public sources of contact information, such as an online directory. This step represents existing types of searches for contact information. The component may combine this information with the previously described search results, and rank the results based on where the component found each result. For example, the component may rank results from the user's own contacts higher than results from public sources of contact information.

Continuing in block 590, the component provides the search results to the user in response to the user request. For example, the system may display a list of search results from which the user can select one or more results to contact the contact associated with the result or to add information about the contact into the user's list of contacts. The displayed list may be ordered based on the rank described in the previous example. The user may be able to click on a result to call, email, or make other contact with the contact associated with the result. As described previously, the system may send a notification to the holder of the contact information to request permission to allow the searching user to access the contact's information. Thus, the searching user may have to wait for authorization from the contact holder to view and use contact information associated with a particular search result. After block 590, these steps conclude.

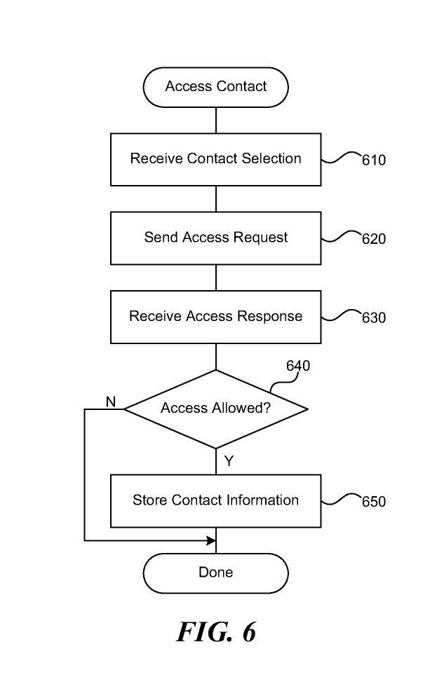

FIG. 6 is a flow diagram that illustrates the processing of the notification component of the contact sharing system, in one embodiment. The component may be invoked after a user has found a relevant contact, such as following the search illustrated in FIG. 5. Beginning in block 610, the component receives a contact selection that the user would like to add to the user's address book. For example, the user may select the contact from a list of search results displayed on the user's mobile device. Continuing in block 620, the component sends an access request (e.g., a notification) to another user responsible for the contact information. For example, the component may send the access request to the user associated with the contact information to ask the user whether the component can share the contact information with the searching user. Alternatively or additionally, when the system found the contact information in the address book of another user, the component may notify that user to ask whether the component can share the identified contact information. The notification may be in the form of an SMS message or a popup in a contact sharing application on the searching user's mobile device. The system may use SMS, for example, where the target user is not running the contact sharing application.

Continuing in block 630, the component receives an access response. For example, if the component sent the notification via an SMS message, the user may reply to the SMS message to provide the response. The access response indicates whether the responsible user allowed or denied the requested access. Continuing in decision block 640, if the user allowed the requested access, then the component continues in block 650, else the component completes. In the event that the user denied the requested access, the system may display an error message or other informational message. Continuing in block 650, the component stores the contact information in the searching user's address book. After block 650, these steps conclude.

In some embodiments, the contact sharing system maintains a record of the source of contact information so that updates can be shared among multiple users. For example, if a first user finds contact information from a second user and the second user updates the contact information, the system may provide the update to the first user. Similarly, the relationship may operate in the other direction so that if the first user updates the contact information, the second user receives the update. The system may identify contacts that are similar among any number of users and provide updates from any of the users to the other users. This simplifies the process of maintaining up-to-date contact information for each of the users.

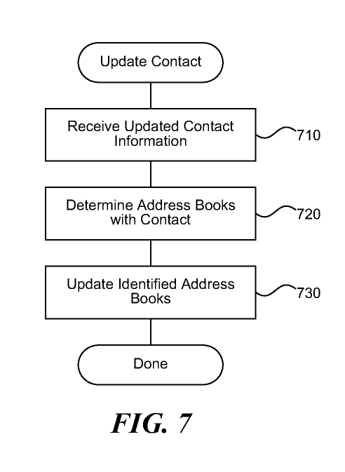

FIG. 7 is a flow diagram that illustrates processing of the update component to share contact updates, in one embodiment. Beginning in block 710, the component receives updated contact information for a user. For example, a user may update the user's address book in response to determining that a contact's information has changed (e.g., a new email address). The user may modify the contact information from an application on the user's mobile phone, on the web, or through another interface to the contact sharing system. Continuing in block 720, the component determines whether address books of other users contain the updated contact. The system may maintain a history that links contact information in an address book with a path through which that information was obtained. For example, if a user performed a search as described herein that identified the contact information in the address book of one of the user's contacts, then when that contact updates the identified contact, the system may provide the updated information to the searching user. Continuing in block 730, the component updates the identified address books with the new contact information. After block 730, these steps conclude.

In some embodiments, the contact sharing system searches beyond a first level of contacts when searching for contact information. For example, the system may search contacts of contacts (second degree) for a person searching for contact information. In addition, the system may search without regard to a searching user's relationship to other users on the server and may instead search all contact information stored on the central service. For example, users of the system may elect whether to make their own contact information publicly or widely available so that users system-wide can find information about them.

In some embodiments, the contact sharing system provides implicit recommendations based on the contact information available from a searching user's contacts. For example, if a searching user is searching for an Italian restaurant, and a particular restaurant is found in the stored contact information of the searching user's contacts, then the system may rank the particular restaurant higher than results from a generally available directory of restaurants. A searching user may be more likely to prefer the same establishments as the user's friends, and thus these results may be more relevant to the user.

From the foregoing, it will be appreciated that specific embodiments of the contact sharing system have been described herein for purposes of illustration, but that various modifications may be made without deviating from the spirit and scope of the invention. For example, although contact information has been described in the examples herein, the system could also be used with other types of information associated with various users, such as documents. Accordingly, the invention is not limited except as by the appended claims.

I/we claim:

1. A computer-implemented method for searching for contact information in response to a user request, the method comprising:
receiving one or more contact search criteria for finding contact information;
identifying contacts of the user that initiated the search;
selecting a contact from the contacts of the user;
searching one or more contacts of the selected contact to determine whether a contact matches the received search criteria;
in response to identifying a matching contact, adding the matching contact to search results; and
providing the search results to the user in response to the user request,
wherein the preceding steps are performed by at least one processor.

2. The method of claim 1 wherein receiving one or more contact search criteria comprises receiving information known about a contact that includes a name.

3. The method of claim 1 wherein identifying contacts of the user comprises downloading a list of contacts from a central contact data store that the user is authorized to access.

4. The method of claim 1 wherein identifying contacts of the user comprises accessing a cached copy of a contact list on a device associated with the user.

5. The method of claim 1 wherein searching one or more contacts comprises sending a request to a central contact store to search one or more data structures for contacts that match the received search criteria.

6. The method of claim 1 wherein searching one or more contacts comprises searching the user's contacts recursively at multiple levels of depth to identify potential matches of the search criteria.

7. The method of claim 1 wherein adding the matching contact to search results comprises storing a list of identified search results to display to the user as the query progresses.

8. The method of claim 1 further comprising searching one or more public sources of contact information and combining the results with results from searching the user's contacts.

9. The method of claim 8 further comprising ranking the search results so that results from the user's contacts are ranked higher than results from the public sources of contact information.

10. The method of claim 1 wherein providing the search results comprises displaying a list of search results from which the user can select one or more results to contact the contact associated with the result.

11. The method of claim 1 wherein providing the search results comprises displaying a list of search results from which the user can select one or more results to add information about the contact into the user's list of contacts.

12. The method of claim 1 further comprising sending a notification to the source of the contact information associated with a search result to request permission to provide the contact information to the user.

13. A computer system for discovering and sharing distributed contact information, the system comprising:
a processor and memory configured to execute software instructions;
an authorization component configured to identify each user of the system;
a contact data store configured to store contact information received from multiple users and provide access to the contact information to multiple users;
a contact entry component configured to provide an interface for receiving contact information from a user;
a sharing component configured to receive access control information from one or more users associated with contact information and store the access control information in the contact data store;
a search component configured to search for contact information in response to a user request to find contact information for a particular person; and
a notification component configured to provide a notification to a holder of contact information identified by the search component, wherein the notification requests permission to provide the contact information to the user.

14. The system of claim 13 wherein the contact data store is centrally accessible so that multiple clients can access the data store from multiple locations.

15. The system of claim 13 wherein the contact data store operates in a distributed manner, such that multiple peers store contact information and connect to one another dynamically to access distributed contact information.

16. The system of claim 13 wherein the sharing component is further configured to receive access control information that specifies whether contacts of a user are visible to other users.

17. The system of claim 13 wherein the sharing component is further configured to receive access control information that specifies levels of access to contact information of a user including allowing contacts of the user to view each other's contact information, but not allowing other users of the system to view the user's contacts.

18. The system of claim 13 wherein the notification component is further configured to provide the notification through a Short Message Service message.

19. The system of claim 13 further comprising an update component configured to provide ongoing updates to contact information shared among multiple users.

20. A computer-readable storage medium comprising instructions for controlling a computer system to share contacts of a user with other users, wherein the instructions, when executed, cause a processor to perform actions comprising:
receiving a list of the user's contacts from a network accessible contact data store that stores relationships between users;
selecting at least one first contact in the received list.
receiving access control information from the user for the selected contact, wherein the access control information indicates whether other users can search the user's contacts to identify contact information for the selected contact;
receiving a notification indication that specifies whether the user wants to be notified when another user requests information from the user for the selected contact; and
storing the access control information and notification indication in the contact data store.
